(19) United States
(12) Patent Application Publication
(10) Pub. No.: US 2005/0276351 A1
(43) Pub. Date: Dec. 15, 2005

(54) Receiving arrangement of a cordless communication system

(76) Inventors: Giuseppe Li Puma, Bochum (DE); Elmar Wagner, Duisburg (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/148,686

(22) Filed: Jun. 9, 2005

Related U.S. Application Data
(63) Continuation of application No. PCT/DE03/03960, filed on Dec. 2, 2003.

(30) Foreign Application Priority Data
Dec. 10, 2002 (DE) DE 102 57 666.1

(51) Int. Cl. H04L 27/14

(52) U.S. Cl. 375/316

(57) ABSTRACT

A receiving arrangement for a cordless communication system includes an analog radio-frequency input section and a digital signal processing device connected downstream thereof. The digital signal processing device has an analog/digital converter which is followed by a digital mixing stage and a decimation unit. The decimation factor of the decimation unit is switchable in order to achieve an advantageous implementation for various systems.

### REFERENCE TO RELATED APPLICATIONS

This application is a continuation of PCT/DE03/03960, filed Dec. 2, 2003 which was not published in English, that claims the benefit of the priority date of German Patent Application No. DE 102 57 666.1, filed on Dec. 10, 2002, the contents of which both are herein incorporated by reference in their entireties.

### FIELD OF THE INVENTION

The invention relates to a receiving arrangement of a cordless communication system.

### BACKGROUND OF THE INVENTION

Cordless digital communication systems such as DECT, WDCT, Bluetooth or the like require receivers which are suitable for transmission and reception of radio-frequency signals which are sent via the air interface and which supply the demodulator with a baseband signal, with as little distortion as possible, in an advantageous manner in terms of complexity. In addition to high sensitivity, a high degree of integration, low costs, low power consumption and flexibility with regard to the applicability to different digital communication systems are desirable. In order to exploit the advantages of digital technology, for example, no temperature dependency, at least a part of the receiver circuit is in this case in the form of digital signal processing elements. In order to allow low-cost receiver implementations, it is desirable for the same receiver to support different mobile radio standards. For example, it would be possible to produce appliances at considerably lower costs if it were possible to use a receiver for the DECT European telephone standard and for the American WDCT Standard at the same time. For reasons relating to integration capability, these receivers may be designed as receivers with a low intermediate frequency (low IF).

Previous receiver concepts use separate receiving modules in an appliance or separate complete receiver units for different standards. Alternatively, circuits are used on the analog side which provide complex switching between different reception bandwidths. The intermediate frequency in the case of DECT, by way of example, is in this case half the channel separation, while it uses the entire channel separation for this purpose in the case of WDCT. Since the channel separation in the case of DECT is half the channel separation in WDCT, the intermediate frequency is thus the same, specifically 864 kHz. Thus, for a receiver which is intended to receive both systems, it must be possible to switch the bandwidth with the same mid-frequency both for the filters and for the demodulator. Even in a digital implementation, the bandwidth must be made switchable, with the same mid-frequency. However, the constant mid-frequency is also dependent on the sampling rate also remaining unchanged. It is therefore necessary to change the coefficients of the filter and of the demodulator.

DE 1 006 042 A1 discloses a conventional receiver concept which operates with one standard, for example the DECT Standard.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

The invention is directed to a receiving arrangement of a cordless communication system, which allows operation in communication systems with a different standard, with minimal complexity.

According to the invention at least two decimation paths with different decimation characteristics are provided that ensure that the digital signal processing for communication systems with different standards is performed with minimal complexity. One exemplary refinement of the invention provides that a first decimation process is carried out in one decimation stage, and the decimation process appropriate for each standard is carried out after subdivision into different decimation paths, which are each associated with different standards.

In a second exemplary embodiment, no previous decimation is carried out, and the decimation that is required for each standard is carried out completely in each path.

Finally, the invention provides that, together with the selection of the decimation path, appropriate channel filters and/or input amplifiers are/is selected in the analog radio-frequency input stage.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention will be explained in detail in the following text with reference to the drawing, in which:

FIG. 1 is a block diagram illustrating a receiving arrangement in a cordless communication system;

FIG. 2 is a block diagram illustrating a portion of a receiving arrangement according to a first exemplary embodiment of the invention; and

FIG. 3 is a block diagram illustrating a portion of a receiving arrangement according to a second exemplary embodiment of the invention.

### DETAILED DESCRIPTION OF THE INVENTION

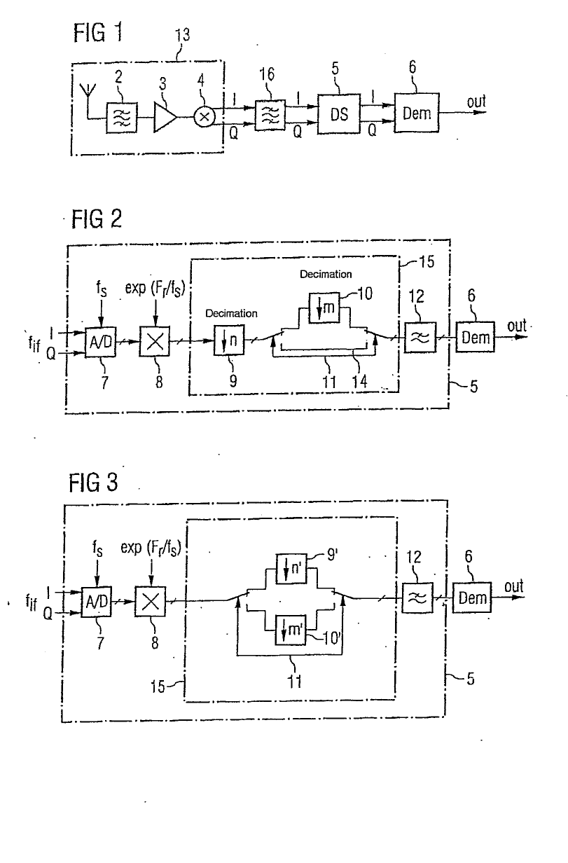

FIG. 1 shows, in the form of a block diagram, a receiving antenna which supplies received signals to an input filter 2. The signals which are filtered in the input filter 2, or RF bandpass filter, are supplied to an input amplifier which is typically a low-noise amplifier (LNA). The output signal from the input amplifier 3 is supplied to a first mixing stage 4, where complex mixing is carried out to form a complex intermediate frequency, which has the components I and Q, with a 90 degree phase shift between them. These two components I and Q are supplied, after passing through a channel filter 16 to a digital signal processing unit 5, in which analog/digital conversion is first of all carried out, followed by digital signal processing in such a way that the components I and Q can be supplied on the output side to a demodulator 6, which uses the complex components I and Q to produce a real output signal OUT.

FIG. 2 shows a first exemplary embodiment of the digital signal processing unit 5 in the form of a detailed block diagram. The two analog components I and Q at the intermediate frequency f_{if} are supplied to the analog/digital converter 7, where they are sampled at a sampling rate fₛ. The sampling process is carried out based on oversampling, with respect to the channel bandwidth.

Specifically, the meaning of this is as follows: the data rate according to the DECT Standard is Rbits=1.152 Mbit/s. The data rate according to the WDCT Standard is only half as great, that is to say Rbits WDCT=576 kbit/s. If a sampling frequency of fₛ=72×Rbits is provided for the DECT Standard, then this results in the same sampling frequency fₛ for the WDCT Standard, since the data rate is half as great as that for fₛ=144×Rbits for WDCT.

The digitized I and Q components are then supplied to a complex digital mixer 8 which converts the signals to a so-called baseband, so that the bandwidth is independent of the mid-frequency. This avoids the use of complex bandpass filters, and it is possible to use simple low-pass filters. After the digital mixing stage 8, the signals are supplied to a decimation unit 15.

In the illustrated exemplary embodiment in FIG. 2, this decimation unit 15 first of all has a first decimation stage 9, where decimation is carried out by the factor n. Depending on which path is chosen, a signal path device 11 now supplies the output signal from the first decimation stage 9 to a second decimation stage 10 or to a bypass 14, which bypasses the second decimation stage. Decimation is carried out by the factor m in the second decimation stage 10. Downstream from the bypass 14 or the second decimation stage 10, the signal path selection device 11 joins the two paths together again. For the specific situation where the receiver is intended to comply not only with the DECT Standard but also with the WDCT Standard, a decimation process is carried out in the first decimation stage 9 using n=8, and a decimation process using m=2 is carried out in the second decimation stage 10.

For the DECT Standard, the bypass path 14 via the signal selection device 11 is selected for further signal processing, so that overall decimation by 8 is provided for the decimation unit 15. For the WDCT Standard the path via the second decimation stage 10 is selected via the signal path selection device 11. In this case, additional decimation is carried out with m=2. This results in overall decimation by 16 for the WDCT Standard. In consequence, the signals at the end of the decimation unit 15, both for the DECT Standard and for the WDCT Standard have the same ratio of the sampling rate to the bit rate. This means that all the subsequent functional blocks, such as the digital filter devices 12 in which filtering and equalization are carried out and the demodulation circuit 6 can be used without any change. In addition, although this is also envisaged for previous appliances which are suitable for two or more standards, switching on the RF input side must be carried out in parallel with the switching by the decimation stage 15. This means that not only must the input filter 2 be set to the appropriate frequency and bandwidth for the standard, but the low-noise input amplifier must be provided with an appropriately matched bandwidth corresponding to the selected standard. This may be done in such a way that either different filters and amplifier paths are provided depending on the selected standard, or the filters and amplifiers are made to be switchable in an appropriate form.

Since the previous exemplary embodiment has been described on the basis of the DECT Standard and the WDCT Standard, it should now be mentioned that the invention is not just restricted to combining these two standards in one receiver circuit. For example, it is possible to use additional standards or other standards. In this case, it is possible by suitable choice of the sampling and decimation to adapt the concept according to the invention and/or to provide the appliance for more than just two standards. In this situation additional paths may be provided, corresponding to the required decimation unit 15.

In the exemplary embodiment illustrated in FIG. 3, which corresponds generally to the exemplary embodiment shown in FIG. 2, identical parts are provided with the same reference symbols. The difference, as a consequence of which the description is restricted to FIG. 3, is that no common decimation for both standards is carried out before the paths are split. A first decimation stage 9′ and a second decimation stage 10′ are provided, with respective decimations of n′ and m′, in each of which the entire decimation process is carried out in accordance with the selected standard. This is the situation whenever the decimation for one of the standards is not a multiple of the decimation for the respective other standard.

Once again, more than two paths may be provided in this case.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A receiving arrangement for a cordless communication system, comprising:
an analog radio-frequency input section; and
a digital signal processing device connected downstream of the analog radio-frequency input section, the digital signal processing device comprising:
an analog/digital converter;
a digital mixing stage coupled to an output of the analog/digital converter, and configured to generate a baseband signal; and
a decimation unit coupled to an output of the digital mixing stage, and configured to perform a decimation operation on the baseband signal, comprising at least two decimation paths with different decimation characteristics.

2. The receiving arrangement of claim 1, further comprising a decimation path selection device configured to select one of the at least two decimation paths.

3. The receiving arrangement of claim 2, wherein the decimation unit further comprises a common decimation filter upstream of the decimation path selection device.

4. The receiving arrangement of claim 2, wherein at least one of the at least two decimation paths comprises a further decimation filter.

5. The receiving arrangement of claim 1, wherein one of the decimation paths comprises a bypass path.

6. The receiving arrangement of claim 1, wherein the radio-frequency input section comprises a switchable channel filter for different channel bandwidths, and configured to selectively pass a predetermined range of signal frequencies associated with a selected channel bandwidth and a predetermined decimation path.

7. The receiving arrangement of claim 6, wherein the channel filter downstream of a radio-frequency input circuit comprising a band mid-frequency tunable to a predetermined reception frequency.

8. A receiving arrangement, comprising:
an analog radio-frequency input section configured to receive a radio-frequency signal and convert it to an intermediate frequency signal; and
a digital signal processing section configured to receive the intermediate frequency signal and convert it to digital data, the digital signal processing section comprising a decimation unit configured to selectively remove bits associated with the digital data, wherein the decimation unit is configured to selectively remove differing amounts of bits based on a control signal.

9. The receiving arrangement of claim 8, wherein the decimation unit comprises at least two decimation paths comprising different decimation characteristics.

10. The receiving arrangement of claim 9, wherein one of the decimation paths comprises an m-decimation characteristic operable to remove every m^{th} bit, wherein m comprises an integer greater than 1, and another of the decimation paths comprises a bypass path where no decimation takes place therein.

11. The receiving arrangement of claim 10, further comprising a decimation path selection device configured to select one of the at least two decimation paths based on the control signal.

12. The receiving arrangement-of claim 11, wherein the control signal dictates one of a plurality of different communication protocols associated with the radio-frequency signal.

13. The receiving arrangement of claim 12, wherein the communication protocols comprise DECT, WDCT, or Bluetooth.

14. The receiving arrangement of claim 10, further comprising a common decimation filter coupled to the at least two decimation paths, and configured to remove every n^{th} bit, wherein n comprises an integer greater than 1.

15. The receiving arrangement of claim 14, wherein the common decimation filter is upstream of the at least two decimation paths.

16. The receiving arrangement of claim 8, wherein the digital signal processing section further comprises an analog/digital converter configured to receive the intermediate frequency signal from the radio-frequency input section and generate a pre-processed digital bit stream based thereon.

17. The receiving arrangement of claim 16, wherein the digital signal processing section further comprises a digital mixer configured to receive the pre-processed digital bit stream associated with the intermediate frequency signal and down-convert the data to a processed baseband bit stream comprising the digital data.

18. The receiving arrangement of claim 10, further comprising a demodulator configured to receive and demodulate the decimated digital data, and output a demodulated digital data stream comprising useful data.
